(19) United States
(12) Patent Application Publication
(10) Pub. No.: US 2025/0202323 A1
(43) Pub. Date: Jun. 19, 2025

(54) POWER TRANSMISSION DEVICE FOR ENERGIZING A ROTOR WINDING OF AN ELECTRIC MACHINE, AND ELECTRIC MACHINE

(71) Applicant: AUDI AG, Ingolstadt (DE)

(72) Inventor: Thomas HECKEL, Kipfenberg (DE)

(21) Appl. No.: 18/979,424

(22) Filed: Dec. 12, 2024

(30) Foreign Application Priority Data
Dec. 13, 2023 (DE) 102023135021.8

(51) Int. Cl. H02K 13/00; H01R 39/08; H01R 39/26; H02K 13/10

(52) U.S. Cl. CPC H02K 13/003; H01R 39/08; H01R 39/26; H02K 13/10

(57) ABSTRACT

A power transmission device for energizing an electrical winding carried by a rotor of an electric machine is disclosed, and may include a slip ring unit, at least one slip ring non-rotatably fastened to the slip ring unit, a brush unit, and at least two brushes held on the brush unit for parallel energization of the slip ring. The at least one slip ring may be configured to be electrically connected to the winding. The brushes may be held on the brush unit such that the brushes may touch the slip ring an establish an electrical contact via a contact surface. When the slip ring unit rotates, the brushes may sweep over a running surface on the slip ring The brushes may be configured such that the respective running surfaces on the slip ring do not overlap. An electric machine with such a power transmission device is also disclosed.

### BACKGROUND

### Technical Field

The disclosure relates to a power transmission device for energizing an electrical winding carried by a rotor of an electric machine, and such an electric machine.

### Description of the Related Art

A separately excited electric machine has a rotor that is rotatably mounted in a stator and is embodied with windings that can be energized via a power transmission system (also referred to herein as a power transmission device). The power transmission system commonly has a slip ring unit and a brush unit. The slip ring unit has at least one slip ring. The brush unit commonly has several brushes. During operation, the brushes each have a contact surface that makes sliding contact with the rotating slip ring along a so-called running surface (also called a running track or track), with several of the brushes using the same running surface of the slip ring.

The mechanical friction between the brushes and the slip ring as well as the power load lead to wear on the slip ring (material removal), which limits service life of the slip ring. There is increased wear on the slip ring because several brushes use the same running surface.

For wear monitoring, for example, DE102014007690A1 discloses a slip ring unit having several slip rings and associated brushes, wherein an electrical operating current between a stationary connection and a rotating unit is always conducted via a single brush and the associated slip ring. Wear monitoring of the slip ring unit provides for two further slip rings that are conductively connected to one another via an electrical connection in order to optionally conduct a testing current via a brush into the one further slip ring, and to the other further slip ring via a brush associated with this slip ring, and to close a test circuit between the two brushes. In one embodiment, the two further slip rings associated with the test circuit can also form a physical unit without the additional electrical connection and can be designed as a slip ring that is contacted by the two brushes of the test circuit on two axially spaced tracks.

A structure of a slip ring module for increasing a creepage distance between adjacent slip rings in a compact design is disclosed in EP3021428A1.

U.S. Patent Application Publication No. 2017/0214202 discloses a wear indicator for state monitoring of a slip ring system.

### BRIEF SUMMARY

Against this background, the present disclosure provides a power transmission device for energizing a rotor winding of an electric machine, and an electric machine having a power transmission device, which may have low wear and a long service life or lifespan.

It should be noted that the features set forth individually in the claims can be combined with one another in any technically reasonable manner (including across category boundaries, for example between method and device) and show further configurations of the disclosure. The description additionally characterizes and specifies the disclosure, particularly in connection with the figures.

It should also be noted that a conjunction “and/or” used herein, which is placed between two features and links them together, is always to be interpreted in such a way that in a first configuration of the subject matter according to the disclosure only the first feature can be present, in a second configuration only the second feature can be present, and in a third configuration both the first and the second feature can be present.

The disclosure is directed to a power transmission device for energizing an electrical winding carried by a rotor of an electric machine (also referred to herein as a rotor winding). The power transmission device may have a slip ring unit and a brush unit. At least one slip ring may be fastened non-rotatably to the slip ring unit, and the at least one slip ring may be electrically connected to the rotor winding or may be connected in a state installed in the electric machine. For this purpose, the slip ring unit may, for example, provide an electrical connection (e.g., terminal, soldering lug or similar) which may be electrically connected to the slip ring on the one hand and to which the rotor winding may be electrically connected on the other.

At least two brushes may be held on the brush unit for parallel energization of the slip ring. In such a configuration, current of the same current direction may be supplied to or removed from the slip ring via the at least two brushes during energization. The at least two brushes may be associated with the same slip ring.

Furthermore, the slip ring unit may be mounted on the brush unit so that the slip ring unit may rotate about an axis of rotation, and the brushes may be held on the brush unit in such a way that the brushes touch the slip ring so as to establish an electrical contact via a contact surface which, when the slip ring unit rotates (i.e., rotation relative to the brush unit), sweeps over a running surface (also referred to as a running track or track) on the slip ring. The brushes may preferably be held resiliently in the direction of the contact surface and exert a spring pressure on the contact surface. According to the disclosure, the at least two brushes may be configured such that their respective running surfaces on the slip ring do not overlap.

It shall be understood that the slip ring unit, when installed in the electric machine in a normal operating state, may be mechanically connected in a rotatably fixed manner to the rotor of the electric machine, such that the slip ring unit rotates together with the rotor relative to the brush unit.

For energization of the rotor winding, at least one electrical connection may preferably be provided on the brush unit, which may be in an electrically conductive connection with the brushes. The brush unit may be connected to an external energy source (e.g., motor operation) or energy sink (e.g., generator operation) via the electrical connection. Accordingly, an electrical current may flow via the brushes and the associated contacted slip ring between the electrical connection of the brush unit and the rotor winding electrically connected to the slip ring.

As mentioned, the brushes may be provided for parallel energization of the same slip ring, i.e., the direction of current flowing between the at least two brushes and the associated slip ring may be identical. Such a configuration may enable a greater electrical power to be transmitted between the brushes and the slip ring and ultimately to the rotor winding. In any case, the current transmission between the brushes and the associated slip ring within the meaning of the present disclosure may be able to provide sufficient electrical power for the intended operation of the electric machine for energizing the rotor winding. In addition, the parallel energization of the slip ring via several brushes may create redundancy with regard to the energization, which may significantly increase the reliability of the power transmission device or the electric machine.

Each of the at least two brushes sweeps over its own separate running surface on the slip ring, which does not overlap with another running surface on the same slip ring, and therefore, the wear of a running surface of the slip ring may be significantly reduced compared to a conventional configuration wherein several brushes share the same running surface on the slip ring. The present disclosure may enable the total wear of the power transmission device to be distributed over several running surfaces of the slip ring, thereby significantly increasing the service life or lifespan of the power transmission device.

In some embodiments that enables a particularly compact structure, at least three brushes may be held on the brush unit, with the running surfaces of two of the three brushes on the slip ring at least partially overlapping. Although the material removal in the overlapping areas of the running surfaces increases, a more compact arrangement of the brushes may offer a greater advantage in certain applications compared to the higher wear. The power transmission device may be flexibly adapted to the respective application situation in a structurally simple manner.

In some embodiments, more than two brushes may be held on the brush unit. Each of the brushes may sweep over non-overlapping running surfaces on the slip ring. In this way, a maximum service life of the power transmission device may be ensured and, at the same time, the ability of the power transmission device to transmit electrical power and/or reliability (redundancy) of the power transmission device may be improved.

In further embodiments, at least one of the running surfaces of the brushes may be located on a radial outer peripheral surface of the slip ring, i.e., on a lateral surface of the slip ring. Such a configuration may enable a radial arrangement of the brushes in relation to the slip ring, i.e., the brushes can be spring-loaded in the radial direction against the lateral surface of the slip ring. Such a configuration may enable a compact structure of the brush unit in the axial direction (i.e., in the direction of the axis of rotation of the slip ring unit). In other embodiments, all running surfaces of the brushes may be located on a radial outer peripheral surface (i.e., lateral surface) of the slip ring.

In further embodiments, at least one of the running surfaces of the brushes may be located on an axial end face of the slip ring. Such a configuration may enable an axial arrangement of the brushes in relation to the slip ring, i.e., the brushes can be spring-loaded in the axial direction against the end face of the slip ring. Such a configuration may enable a compact structure of the brush unit in the radial direction (i.e., in the direction perpendicular to the axis of rotation of the slip ring unit). In yet other embodiments, all the running surfaces of the brushes may be located on an axial end face of the slip ring.

In still other embodiments, the running surfaces of the brushes may be located on two opposite axial end faces of the slip ring.

In some embodiments, the above-described axial and radial arrangement of the brushes may be combined, i.e., to provide at least one of the brushes in a radial arrangement to the slip ring and at least another of the brushes in an axial arrangement.

According to further embodiments, at least two slip rings may be fastened non-rotatably at the slip ring unit, one of which may be electrically connectable to a first pole (e.g., positive pole) of the winding or may be connected in a state installed in the electric machine, and the other may be electrically connectable to a second pole (e.g., negative pole) of the winding or may be connected in a state installed in the electric machine. At least two brushes associated with one slip ring and at least two brushes associated with the other slip ring may be held on the brush unit in such a way that the brushes associated with the respective slip rings each touch the slip ring so as to establish an electrical contact via a corresponding contact surface that sweeps over a running surface on the respective slip ring when the slip ring unit rotates. The brushes associated with the respective slip rings may be configured in such a way that their respective running surfaces on the respective slip ring do not overlap. In other words, each slip ring of the slip ring unit may supply one pole of the rotor winding. The brushes associated with a single slip ring may ensure that the pole of the winding is energized in parallel. For each pole, the brushes may be configured in relation to the respective slip ring in such a way that the running surfaces they sweep over on the same slip ring are separate and do not overlap.

Furthermore, subject matter of the present disclosure may be an electric machine having a stator, a rotor which is mounted in the stator so as to be rotatable and which carries at least one electrical winding, and a power transmission device for energizing the winding, wherein the power transmission device is configured according to any one of the embodiments disclosed herein. The slip ring unit may be connected non-rotatably to the rotor so that the slip ring unit rotates together with the rotor. The rotor winding may be electrically connected to the at least one slip ring.

In some embodiments, the electric machine may be configured as a separately excited synchronous machine (FSM).

### BRIEF DESCRIPTION OF THE SEVERAL VIEWS OF THE DRAWINGS

FIG. 1 shows a perspective view of a power transmission device according to the prior art.

FIG. 2 shows a side view of a section of the power transmission device according to the prior art of FIG. 1.

FIG. 3 shows a perspective view of a power transmission device according to an embodiment of the present disclosure.

FIG. 4 shows a side view of a section of the power transmission device of FIG. 3.

### DETAILED DESCRIPTION

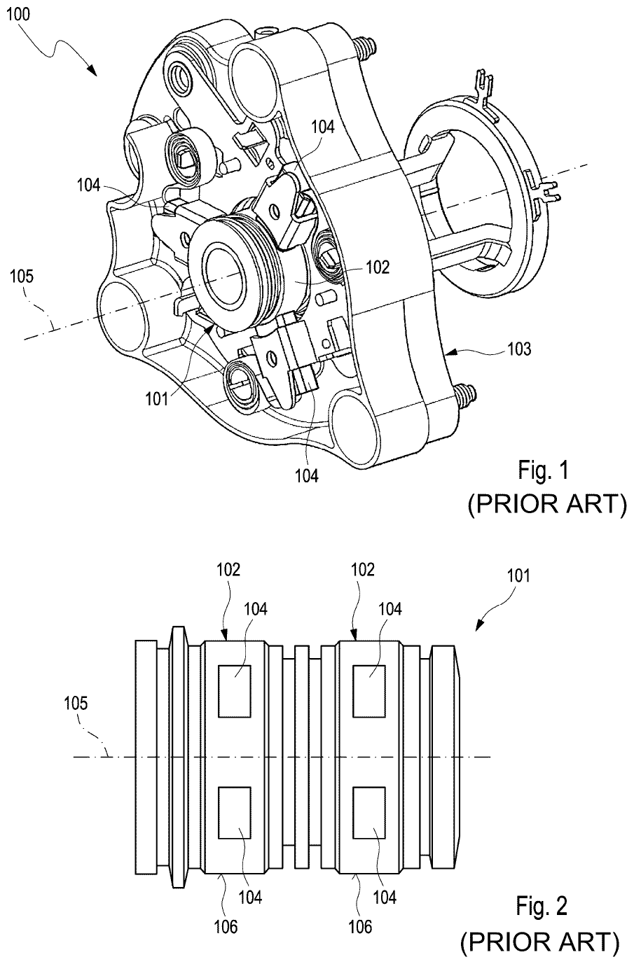

FIG. 1 shows a perspective view of a power transmission device 100 according to the prior art. Power transmission device 100 has a slip ring unit 101, to two slip rings 102 (shown in FIG. 2) are attached. Power transmission device 100 also has a brush unit 103, to which three brushes 104 are held for slip ring 102 shown in FIG. 1. Slip ring unit 101 is mounted on the brush unit 103 so as to be rotatable about an axis of rotation 105. Brushes 104 establish electrical contact with respective slip ring 102. When slip ring unit 101 rotates relative to brush unit 103, brushes 104 sweep over a running surface 106 on slip ring 102, as shown in FIG. 2.

FIG. 2 shows a side view of a section of power transmission device 100 according to the prior art from FIG. 1. The section shows that part of slip ring unit 101 on which two slip rings 102 are arranged. FIG. 2 indicates that brushes 104 associated with respective slip ring 102 all use the same running surface 106. The mechanical friction between brushes 104 and respective slip ring 102 as well as the current load lead to increased wear of slip rings 102 (material removal), since several brushes 104 use the same running surface for each slip ring 102.

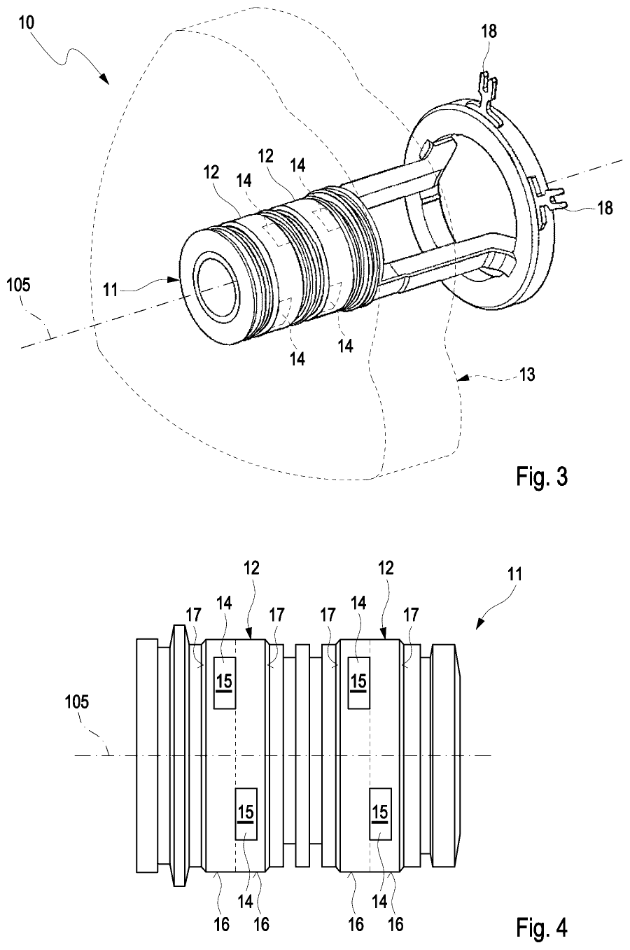

FIG. 3 shows a perspective view of a power transmission device 10 according to an embodiment of the present disclosure. Power transmission device 10 may be configured to energize an electrical winding (not shown) carried by a rotor (not shown) of an electric machine (also not shown) and may include a slip ring unit 11 to which at least one slip ring 12 (in this case two slip rings 12) is or are attached non-rotatably. The at least one, or in the present case two, slip rings 12 may be electrically connectable to the winding or may be connected in a state of power transmission device 10 installed in the electric machine.

Furthermore, power transmission device 10 may include a brush unit 13, which is shown as semi-transparent in FIG. 3 in order to visualize two slip rings 12 of slip ring unit 11. At least two brushes 14 may be held on brush unit 13 for parallel energization of each slip ring 12. In the exemplary embodiment shown here, three brushes 14 are provided for parallel energization per slip ring 12, but this number is not necessarily fixed. More than three brushes 14 may also be provided per slip ring 12, or just two brushes 14.

Slip ring unit 11 may be mounted on brush unit 13 so as to be rotatable about axis of rotation 105. In combination with the electric machine not shown here, for example a separately excited synchronous machine, slip ring unit 11 may be connected non-rotatably to the rotor so that both components rotate together about axis of rotation 105 relative to brush unit 13 when the electric machine is operating.

Furthermore, brushes 14 may be held on brush unit 13 in such a way that they touch respective slip ring 12 so as to establish an electrical contact via a respective contact surface 15 in each case, wherein contact surface 15 sweeps over a running surface 16 on respective slip ring 12 when slip ring unit 11 rotates relative to brush unit 13, as shown in FIG. 4.

FIG. 4 shows a side view of a section of power transmission device 10 from FIG. 3. The section shown represents that part of slip ring unit 11 on which two slip rings 12 are arranged. FIG. 4 indicates that brushes 14 associated with respective slip ring 12, of which two contact surfaces 15 per slip ring 12 can be seen in FIG. 4, may use separate running surfaces 16 (also referred to as running track or track). This means that running surfaces 16 of brushes 14 associated with the same slip ring 12 for its parallel energization do not overlap. Wear of each running surface 16 may be reduced, as the total wear of a slip ring 12 may be divided between several running surfaces 16. The service life or lifespan of slip rings 12 may be significantly increased.

In order to form non-overlapping running surfaces 16 per slip ring 12, brushes 14 in the present case may be held offset from one another in the axial direction, i.e., in the direction of axis of rotation 105, on brush unit 13.

In the embodiment of power transmission device 10 shown in FIGS. 3 and 4, brushes 14 are held resiliently against respective slip rings 12 in the radial direction, i.e., perpendicular to axis of rotation 105. Running surfaces 16 of brushes 14 may thus be located on a radial outer peripheral surface (i.e., lateral surface) of respective slip rings 12. However, the disclosure is not limited to the radial arrangement of brushes 14 and running surfaces 16. At least one of brushes 14 or all of brushes 14 may be arranged on brush unit 13 in such a way that running surfaces 16 of brushes 14 are located on an axial end face 17 (i.e., on the same or on opposite end faces 17) of respective slip ring(s) 12.

It shall be understood that in the case of an axial arrangement of the brush(es), a slip disk (not shown) may be provided instead of illustrated slip ring 12, which provides the same function as slip ring 12, but can have a larger radial extent than the latter. In the axial extent, however, the slip disk may be shorter than slip ring 12. Such a configuration may save material for the slip ring or the slip disk on the one hand and, on the other hand, may provide an overall larger area for the arrangement of several non-overlapping running surfaces (similar to running surfaces 16) on axial end face(s) 17.

In the exemplary power transmission device 10 shown in FIG. 3, one of two slip rings 12 may be electrically connectable or connected to a first pole (e.g., positive pole) of the winding (not shown) and the other of two slip rings 12 may be electrically connectable or connected to a second pole (e.g., negative pole) of the winding. This means that all brushes 14 associated with one of slip rings 12 may each energize the respective pole of the winding in parallel. The respective pole of the winding may be electrically connected to respective slip ring 12, for example via electrical connections 18, e.g., terminals, provided on slip ring unit 11.

This application claims priority to German patent application no. 102023135021.8 filed Dec. 13, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A power transmission device for energizing an electrical winding carried by a rotor of an electric machine, comprising:
a slip ring unit;
at least one slip ring non-rotatably fastened to the slip ring unit, the at least one slip ring configured to be electrically connected to the winding;
a brush unit; and
at least two brushes held on the brush unit for parallel energization of the slip ring,
wherein the slip ring unit is mounted on the brush unit such that the slip ring unit is rotatable about an axis of rotation,
wherein the brushes are held on the brush unit such that the brushes touch the slip ring and establish an electrical contact via a contact surface,
wherein when the slip ring unit rotates, the brushes sweep over a running surface on the slip ring, and
wherein the brushes are configured such that the respective running surfaces on the slip ring do not overlap.

2. The power transmission device according to claim 1, wherein more than two brushes are held on the brush unit, all of which sweep over non-overlapping running surfaces on the slip ring.

3. The power transmission device according to claim 1, wherein at least one of the running surfaces of the brushes is located on a radial outer peripheral surface of the slip ring.

4. The power transmission device according to claim 1, wherein at least one of the running surfaces of the brushes is located on an axial end face of the slip ring.

5. The power transmission device according to claim 4, wherein at least two of the running surfaces of the brushes are located on two opposite axial end faces of the slip ring.

6. The power transmission device according to claim 1, wherein at least two slip rings are fastened non-rotatably to the slip ring unit, a first slip ring of the at least two slip rings electrically connectable to a first pole of the winding and a second slip ring of the at least two slip rings configured to be electrically connected to a second pole of the winding, and
wherein at least two brushes associated with the first slip ring and at least two brushes associated with the second slip ring are held on the brush unit such that the brushes associated with the respective slip rings each touch the respective slip ring and establish an electrical contact via a corresponding contact surface
wherein when the slip ring unit rotates, the brushes sweep over a running surface on the respective slip ring,
wherein the brushes associated with the respective slip rings are configure such that the running surfaces on the respective slip ring do not overlap.

7. An electric machine comprising:
a stator,
a rotor rotatably mounted in the stator and configured to carry at least one electrical winding, and
a power transmission device for energizing the winding, the power transmission device comprising:
a slip ring unit;
at least one slip ring non-rotatably fastened to the slip ring unit, the at least one slip ring configured to be electrically connected to the winding;
a brush unit; and
at least three brushes held on the brush unit for parallel energization of the slip ring,
wherein the slip ring unit is mounted on the brush unit such that the slip ring unit is rotatable about an axis of rotation,
wherein the brushes are held on the brush unit such that the brushes touch the slip ring and establish an electrical contact via a contact surface,
wherein when the slip ring unit rotates, the brushes sweep over a running surface on the slip ring,
wherein the brushes are configured such that the respective running surfaces on the slip ring do not overlap, and
wherein the slip ring unit is connected non-rotatably to the rotor and the winding is electrically connected to the at least one slip ring.

8. The electric machine according to claim 7, wherein the electric machine is configured as a separately excited synchronous machine.

9. A power transmission device for energizing an electrical winding carried by a rotor of an electric machine, comprising:
a slip ring unit;
at least one slip ring non-rotatably fastened to the slip ring unit, the at least one slip ring configured to be electrically connected to the winding;
a brush unit; and
at least two brushes held on the brush unit for parallel energization of the slip ring,
wherein the slip ring unit is mounted on the brush unit such that the slip ring unit is rotatable about an axis of rotation,
wherein the brushes are held on the brush unit such that the brushes touch the slip ring and establish an electrical contact via a contact surface,
wherein when the slip ring unit rotates, the brushes sweep over a running surface on the slip ring, and
wherein the brushes are configured such that the running surfaces of two of the three brushes on the slip ring at least partially overlap.
